(19) United States
(12) Patent Application Publication
(10) Pub. No.: US 2021/0222678 A1
(43) Pub. Date: Jul. 22, 2021

(54) WIND TURBINE & METHOD FOR INSTALLING A WIND TURBINE

(71) Applicant: Floating Energy Systems Ltd., Nottingham (GB)

(72) Inventor: Gary Ross, Surrey (GB)

(21) Appl. No.: 17/055,632

(22) PCT Filed: May 22, 2019
(86) PCT No.: PCT/GB2019/051406

§ 371 Date: Nov. 16, 2020

(30) Foreign Application Priority Data
May 22, 2018 (GB) 1808375.8

(51) Int. Cl. F03D 13/25; B63B 35/44

(52) U.S. Cl. CPC F03D 13/25; B63B 35/44; B63B 2035/446; F05B 2240/93; F05B 2240/95

(57) ABSTRACT

A wind turbine for deployment offshore. The wind turbine including: a tower-float assembly having a tower (3) for supporting a nacelle (13a) and a rotor (13b), and a float (5) arranged to maintain at least part of the tower above a surface of a body of water; a keel assembly (7) including at least one keel module (25) and at least one rod (9) connecting the keel module to the tower-float assembly, wherein the at least one rod is arranged to move relative to the tower-float assembly to deploy the keel module, and the keel module is movable relative to the tower-float assembly, in response to movement of the at least one rod, between a non-deployed position proximal the tower-float assembly and a deployed position which is distal from the tower-float assembly in a downwardly direction, thereby increasing an effective length of the wind turbine; and the at least one rod is arranged to transfer bending moments to the tower-float assembly.

### FIELD OF THE INVENTION

The present invention relates to a wind turbine and a method for installing a wind turbine.

### BACKGROUND

The current generation of offshore wind turbines is installed in water depths such that the foundation for the mast and turbine assembly can be secured in the seabed as a single driven pile. A general limit for such a foundation is around 40 m water depth. Depths beyond this require either steel lattice structures secured with multiple driven piles or large gravity base structures of considerable mass to achieve a seabed supported foundation. While such designs have proven economic for recovery of offshore hydrocarbon deposits, the required capital cost compared with the energy generated per turbine for commercial sale makes fixed offshore foundations for single wind turbines uneconomic beyond approximately 60 m. Therefore, wind farm developments beyond continental shelf depths, or in geographic locations lacking a continental shelf, may consider mounting wind turbines on floating foundations.

Demonstration floating wind turbine plant to date has been deployed in a quantity and at a capacity that generates electric power with marginal return or requiring considerable financial subsidy to make the test project viable. Commercial interest in floating wind farms is now focusing on scaleability and industrialization: development of multiple floating wind turbine units that collectively generate electrical power at a price attractive to the consumer but with CAPEX and OPEX levels that provide an attractive rate of return to the investor.

The collective capacity of an offshore wind farm, or one phase of a larger project, currently lies between 500 and 1000 MW. Given a target capacity of 10-12 MW for a single wind turbine unit, a commercial proposition for an offshore windfarm must target between 42 and 100 units per wind farm or wind farm phase. Such a scale of development demands floating sub-structures that can be assembled and installed in a timely manner. This will shorten the delay between the initial commitment of capital to the wind farm development and the start of electrical power generation to the grid and so achieve a return on investment.

To date, floating foundation technology has adapted designs developed in the offshore hydrocarbon industry, broadly based on the following definitions:

Semi-submersible (FIG. 1): consists of vertical column buoyancy tanks 2 which individually have relatively small water plane area 4 but, when interconnected with horizontal tubulars 6, create a single buoyant structure with a distributed water plane area. Though the centre of mass 8 (or centre of gravity) is generally higher than the centre of buoyancy 10, the distributed water plane area ensures the structure's stability on water. In FIG. 2, as the floating unit pitches and rolls 12, the centre of buoyancy 10 shifts across sufficiently to maintain a buoyancy-weight lever arm, X, 14 that prevents capsizing. As well as pitch and roll 12, a semi-submersible will heave 16 and sway 18 in response to wave motion.

Spar (FIG. 3): a spar is a single floating vertical column 20 whose water plane area 22 is that of the tube cross section and is typically circular. To compensate for its poor water plane area stability, the spar maintains a centre of mass 24 below its centre of buoyancy 26. The spar achieves this with a considerably deeper draft than a semi-submersible using solid ballast packed into its keel (28). Thus, in FIG. 4, the buoyancy-weight lever arm, x, 30 acts such that the spar can never capsize. A spar will also heave 16, sway 18 and roll/pitch 12 with wave motion.

The configurations of the above concepts raise interesting challenges for assembly and multiple unit production when considering an industrial scale development of either using current fabrication approaches.

The semi-submersible concept proposed in WO2009/131826 exhibits increasing separation between the vertical columns for larger capacity turbines compared with the original pilot test design. As turbine sizes and weights increase, any further column separation to achieve stability may result in a larger foundation footprint and restrict access to preferred assembly ports.

Semi-submersible construction has used and continues to propose shipyard dry docks for final assembly. This restricts assembly site options while proximity of an existing dry dock to the offshore windfarm site is not guaranteed. Increasing the distance between the assembly and delivery sites raises potential schedule risks and transport costs when towing completed units over excessively large distances.

A restriction to a dry dock facility also limits the option to locate the final assembly site close to the wind turbine component manufacturing plant where there are established machining and technical expertise resources. Material and resources to support the turbine installation have to be mobilised to the dry dock site.

Furthermore, dry docks are dimensioned to suit the width:length ratio of commercial shipping which may not be compatible with the proposed width dimensions of a semi-submersible foundation.

At a practical level, the builder of a batch of floating offshore wind turbines would have to compete with other commercial enterprises requiring access to a dry dock. To complete a production run of 100 such units without a delay to subsequent dry dock bookings presents a considerable production challenge and commercial risk for both the windfarm project delivery schedule and the dry dock. Failure to meet the production deadline would impact on the commercial viability of floating windfarms in terms of market confidence in the production capabilities of the technology.

Both the semi-submersible and spar concepts minimize construction risk through full assembly and testing of the floating foundation, turbine mast, nacelle and rotor blades prior to tow out to site. While this removes exposure to risk in open seas, the spar foundation must be brought vertical in sheltered water to enable full pre-assembly of the turbine. Such a sheltered water location must be deeper than the draft of the spar foundation and places a constraint on areas suitable for such a method of assembly.

Furthermore, the water depths along the tow route to installation site must be sufficiently deep to allow the spar keel to clear any potential raised seabed features along the route.

Additionally, access to a port facility with sufficient water depth to moor an upright spar alongside the quay is very unlikely. Therefore, a spar-based floating windfarm solution relies on floating crane availability for the duration of the assembly phase to transfer assembled turbines from the quayside to each spar at the temporary deep, sheltered water parking site.

WO 2017/157399 considers a design to address some of the shortcomings of semi-submersible and spar concepts. A feature of this system is a separate water ballast tank suspended by lugs and shackles from a floating hull that, when flooded, acts as a counterweight. This approach increases the overall displacement, and hence the immersed depth, of the floating foundation unit in a static condition. However, by their pin-jointed nature, shackle and lug connections transfer limited moment loads back to their point of attachment compared with fixed ended connections. During dynamic motion of the proposed assembly, the reduced moment transfer capability between counterweight and floating structure may result in the two bodies moving under separate response functions to environmental loads. The two bodies then interact with one another through the shackle and lug connections. Similar to a dual pendulum, the risk is an overall response to environmental loads that may prove difficult to analyse and predict.

The wire/chain drive gear to raise and lower the counterweight may be mounted on top of the hull buoyancy tanks if they maintain adequate freeboard in operation. However, should the operational case demand that the buoyancy tanks are fully submerged, either the drive gear would have to be operable underwater, increasing CAPEX through higher specification requirements, or else relocated inside the tower transition piece, increasing system complexity.

CN204436705 proposes a similar suspended counterweight for its floating foundation but uses a rigid weight block and secures this rigid weight block to seabed anchors below and to the floating unit above the weight block with wires. The proposed arrangement integrates the weight into the mooring system. CN204436705 has the potential to behave in effect as a two-body system with cable connections between the two separate bodies which, in the absence of moment transfer capability, may result in the two bodies moving under separate response functions to environmental loads.

A further problem with existing wind turbines is that the marine environment can damage equipment mounted thereon, for example by means of corrosion.

The invention seeks to mitigate at least one of the afore-mentioned problems, or at least provide an alternative wind turbine and method for installing a wind turbine.

### SUMMARY OF THE INVENTION

It is an object of the invention to provide a floating wind turbine having a movable keel that is arranged to adjust the position of a centre of mass of the wind turbine. It is a further object of the invention to provide a wind turbine having a movable keel, wherein rods that connect the movable keel to a tower-float assembly transmit bending moments from the keel to the tower-float assembly when the keel is loaded transversely. It is a further object of the invention to provide a wind turbine that is arranged to behave in the manner of a single body in response to movement of the water when the keel is in the deployed position. It is a further object of the invention to provide a wind turbine that includes at least one drive unit arranged to deploy the keel that is temporarily installed on the tower-float assembly. It is a further object of the invention to provide an installation method that enables a wind turbine to be moved easily from relatively shallow water adjacent a quayside assembly position to a relatively deep water installation position. It is a further objective to provide an installation method that reduces the amount of quayside side space required when compared with a traditional wind turbine assembly process, which takes place at a quay.

At least one of the objects is achieved according to the inventions described below.

According to one aspect of the invention there is provided a wind turbine according to claim 1.

When the keel is in the non-deployed position the wind turbine has a shorter length than in the deployed position, and therefore the wind turbine is easier to assemble and install. When the keel is in the deployed position the wind turbine is operationally more stable. The wind turbine has a centre of mass. The centre of mass has a first position when the keel is in the non-deployed position. The centre of mass has a second position when the keel is in the deployed position. The second position is different from the first position. The deployed position of the keel is located deeper into the water than the non-deployed position. Thus, moving the keel to the deployed position increases the length of the wind turbine. Moving the keel towards the deployed position adjusts the centre of mass of the wind turbine from the first position to the second position. The second position is located below the first position, which provides a more stable wind turbine in use.

The at least one rod provides a rigid connection between the keel and the tower-float assembly. Moment loads applied to the keel when the keel is deployed are transmitted to the tower-float assembly via the at least one rod. Therefore the keel and tower-float assembly behave in the manner of a single body in response to movement of the water when the keel is in the deployed position. The arrangement differs from non-rigid connectors such as chains and tethers. Using rods enables the keel module to be supported during transit, to deploy the keel module and to support the keel module in the deployed position.

The keel module is arranged to be suspended in the body of water, it does not engage the sea bed when deployed.

According to another aspect of the invention there is provided a wind turbine for deployment offshore.

The wind turbine can include a tower-float assembly. The tower float assembly can include a tower for supporting a nacelle and a rotor. The tower-float assembly can include a float arranged to maintain at least part of the tower above a surface of a body of water.

The wind turbine can include a keel assembly including at least one keel module and at least one rod connecting the keel module to the tower-float assembly. The at least one rod can be arranged to move relative to the tower-float assembly to deploy the keel module, and the keel module is movable relative to the tower-float assembly in response to movement of the at least one rod, between a non-deployed position proximal the tower-float assembly and a deployed position which is distal from the tower-float assembly. The deployed position which can be distal from the tower-float assembly in a downwardly direction, thereby increasing an effective length of the wind turbine.

The at least one rod can be arranged to transfer bending moments to the tower-float assembly in a deployed condition. The at least one rod can be arranged to transmit at least one of compressive forces and shear forces to the tower-float assembly in the deployed condition.

The at least one rod can be arranged to move translationally relative to the tower-float assembly along a rectilinear path. The keel module can be moveable from the non-deployed position to the deployed position along a rectilinear path. The rectilinear path can be a generally vertical path. The at least one rod can be constrained to move along the rectilinear path only. Thus during deployment and retraction operations only, the keel module can be arranged to move vertically upwards and downwards when the sea is calm. During normal operation of the wind turbine, when the keel module is in the deployed position, the position of the keel module is fixed relative to the float.

The at least one rod can be pivotally attached to the tower-float assembly and is arranged for pivoting movement relative to the tower-float assembly. The keel module can be moveable from the non-deployed position to the deployed position along a curved path, for example an arcuate path. Thus pivoting movement of the at least one rod swings the keel module into the deployed position along an arc of a circle.

The at least one rod can be arranged to pivot through an angle of approximately 90 degrees from a non-deployed position to a deployed position. The wind turbine can include blocking means to prevent the at least one rod from rotating outwardly beyond the vertical. The wind turbine can include locking mechanism to fix the position and/or orientation of the at least one rod with respect to the tower-float assembly, for example when the keel module is in the deployed position.

The at least one rod can be arranged generally horizontally when the keel module is in the non-deployed position and the at least one rod is arranged generally vertically when the keel module is in the deployed position. The at least one rod can pivot in an inwardly direction when moving the keel module from the deployed position to the non-deployed position. The at least one rod can pivot in an outwardly direction when moving the keel module from the non-deployed position to the deployed position.

The wind turbine can include a plurality of rods connecting the keel module to tower-float assembly. This provides a more stable arrangement. For example, each keel module can be connected to the tower-float assembly by n rods, wherein where n is in the range 2 to 10, and preferably in the range 2 to 6. Each rod can be arranged to move relative to the tower-float assembly to deploy the keel module. In some embodiments, each keel module is pivotally attached to the tower-float assembly by at least a pair of rods. The rods associated with a respective keel module can be arranged parallel to one another.

The wind turbine can include a plurality of keel modules. Each keel module can be connected to the tower-float assembly by at least one respective rod, and preferably a plurality of respective rods. The keel modules can be arranged to move as a unit. In some embodiments, the keel modules are arranged to move independently of each other. The rods associated with different keel modules can be arranged parallel to one another.

In an embodiment a first rod connects a first keel member to the tower-float assembly. The first rod is pivotally attached to the tower float assembly at a first pivot axis. A second rod connects a second keel member to the tower-float assembly. The second rod is pivotally attached to the tower float assembly at a second pivot axis. The second rod is arranged to overlap the first rod when the first and second keel modules are in their respective non-deployed positions. This provides a very compact arrangement. The first pivot axis can be vertically offset from the second pivot axis. This facilitates the second rod overlapping the first rod. In an embodiment a third rod connects a third keel member to the tower-float assembly. The third rod is pivotally attached to the tower float assembly at a third pivot axis. The third rod is arranged to overlap at least one of the first and second rods when the first, second and third keel modules are in their respective non-deployed positions. The third pivot axis can be vertically offset from the first and second pivot axes. This facilitates the second rod overlapping the first and/or second rods.

The wind turbine can include a drive system including at least one drive unit arranged to move the keel module from the non-deployed position to the deployed position. The at least one drive unit can be arrange to move the keel module from the deployed position to the non-deployed position.

At least one drive unit can be releasably attached to the tower-float assembly and is removable from the tower-float assembly after the keel is moved to the deployed position. Having removable drive units enables the drive system to be reused on other wind turbines during an installation phase. For example, allowing for delays and repairs, six drive systems could be cycled during a typical windfarm installation campaign for the installation of all wind turbines. When all wind turbines have been installed and their respective keels moved to their respective deployed positions, the drive systems can be returned to shore. After the initial deployment, the drive system will only be required for maintenance purposes or when the installation is decommissioned. This reduces the overall cost of the installation and prevents damage to the drive system due to long-term exposure to sea conditions. The drive systems can be used for future field developments.

The drive system can include a plurality of drive units. For example, the drive system can include at least one drive unit per keel module. This helps to ensure that the keel is raised and lowered evenly. At least some of the drive units are releasably attachable to the tower-float assembly. Preferably each drive unit is releasably attachable to a respective buoyancy aid, such as a respective buoyancy tank.

The wind turbine can include at least one drive unit per rod. This helps to spread the driving load required to raise and lower the keel. It provides a better balanced drive system. Some embodiments include a plurality of drive units per rod.

The wind turbine can include a controller for synchronising operation of the drive units. This enables keel modules to move as a unit. For example it helps the keel modules to remain horizontal when the keel is raised and lowered.

At least one drive unit can comprise a hydraulic drive unit. For example, at least one drive unit can comprise a hydraulic jack.

At least one drive unit can comprise an electric motor. Each drive unit can comprise an electric motor.

At least one drive unit can comprise a strand jack. Each drive unit can comprise a strand jack.

The wind turbine can include a drive mechanism for transmitting drive from the drive unit to the rod.

At least one rod can include drive formations. The drive mechanism can include at least one drive device arranged to selectively engage the drive formations to selectively transmit drive to at least one rod. A plurality of rods can include drive formations. The drive mechanism can include a plurality of drive devices, wherein respective drive devices are each arranged to selectively engage drive formations on respective rods. In some embodiments each rod includes drive formations and the drive mechanism includes at least one drive device per rod that is arranged to selectively engage drive formations on its respective rod. The drive devices can be mounted in a frame. Operation of the drive devices can be synchronised by the controller.

The drive mechanism can include a rack and pinion system. A rack can be applied to each rod. A pinion can be connected to each drive unit. The drive unit is arranged to drive the rod via the rack and pinion system.

At least one of the rods can have a fixed length. Each of the rods can have a fixed length. That is, the at least one rod is not telescopic. At least some of the rods can be made from steel. At least some of the rods are rectilinear. In some embodiments, the rods each have a length that is greater than or equal to 30 m, preferably greater than or equal to 40 m and more preferably greater than or equal to 50 m. In some embodiments the length of the rods is less than or equal to 90 m, preferably less than or equal to 80 m, more preferably less than or equal to 70 m. In some embodiments the rods have a length of around 60 m. The length of the rods used is at least partly determined by the size of the wind turbine, for example can be at least partly determined by the vertical length of the float. The length of the rods used can be dependent on whether the top end of the rod is restrained in operation at the top or base of the float.

At least one of the rods is rigid. At least one rod per keel module is rigid. Preferably each rod is rigid.

At least one rod can be tubular. Preferably each rod is tubular. In some embodiments at least one rod can comprise first and second tubular members arranged concentrically. This is to help provide a sufficient tensile capacity to take dynamic loading and fatigue margin for the life of the rod. The second tubular member can be located within the first tubular member. The second tubular member can be fixed to the first tubular member. In some arrangements, the rods can comprise solid, non-tubular, rods.

A plurality of rods can be connected together by bracing members. This fixes the rods together and the rods move together as a unit. For example, a plurality of connecter members can be connected together at their upper ends by bracing members.

A plurality of rods can be connected together by an annular member. This fixes the rods together and the rods move together as a unit. The annular member can be arranged to fit around, and move relative to, a buoyancy tank.

The wind turbine can include a plurality of guides for guiding movement of the at least one rod relative to the tower-float assembly. Preferably each rod is movably connected to the tower-float assembly by a plurality of guides.

The rod can include a longitudinal axis. At least one rod can be constrained to move along an axis that is co-axial and/or parallel with the longitudinal axis of the rod. Each rod can include a respective longitudinal axis. Each rod can be constrained to move along a respective axis that can be co-axial and/or parallel with the respective longitudinal axis of the rod.

Each keel module can include a housing. The housing can have a plate-like outer structure, that is, the housing can have an overall structure that is relatively flat, like a disk. The housing structure can include beams, and preferably steel beams. The beams can comprise beam sections, such as I, H and channel sections. The beams can be used to form internal and/or external vertical walls of the housing. Plates, such as steel plates, can be provided for upper and lower walls of the housing. The housing can be made from concrete, with or without steel reinforcement. The housing can have a hollow interior. The hollow interior can be arranged to be filled with ballast. The housing can include a plurality of cells for receiving the ballast. Preferably the ballast can include solid material. Preferably the ballast can be in the form of a slurry. The keel module can include a plurality of holes formed in an outer wall to enable fluid contained within the slurry to escape from the keel module.

At least one rod can have a rigid connection with the keel module. This helps the overall structure to behave as a single body. For example, the end of each rod can be located in a respective socket formed in the housing of the keel module.

At least one rod can be connected to a respective keel module housing. At least one rod can be connected to an inner part of the respective keel module housing.

At least one rod can be connected to an outer surface of the respective keel module, such as an upper surface and/or a lower surface. At least one rod can protrude perpendicularly upwards from the outer surface and/or lower surface. Preferably a plurality of rods can protrude perpendicularly upwards from the outer surface and/or upper surface of the keel module. At least one of the upper and lower surfaces can be planar.

At least one keel module can be connected to another keel module by a linkage. Preferably each keel module can be connected to a plurality of other keel modules by respective linkages. In this arrangement the keel modules move as a unit. The linkages can provide a rigid connection. The linkages can allow some movement between keel modules, for example each linkage can be connected to its respective keel modules by a pin connection. In some embodiments the drive system can be arranged to move at least one keel module independently of at least one other keel module.

In use, the keel modules can be positioned in a common plane. The keel can include three keel modules. The keel can have a triangular arrangement when viewed in plan, and preferably an equilateral triangular arrangement. The modules are located within the plane at the apexes of the triangle. In some embodiments each keel module can have a hexagonal shape when viewed in plan. However the keel modules can have other shapes when viewed in plan, such as a rectangular shape. Other more complex shapes can be used.

The float can include at least one buoyancy aid, such as at least one buoyancy tank, and at least one rod can be arranged to move relative to the buoyancy aid, for example by at least one guide. This enables the keel module to move with respect to the buoyancy aid. Preferably a plurality of rods are each movably connected to the buoyancy aid by a plurality of guides.

The float can include a first set of buoyancy aids, such a first set of buoyancy tanks. Each buoyancy aid can have a respective keel module associated therewith. The respective keel module can be movably connected to its respective buoyancy aid by at least one respective rod. Each buoyancy aid can be spaced apart from the tower. For example, each buoyancy aid can be connected to the tower by at least one respective arm protruding from the tower. Each keel module can be located below its respective buoyancy aid. Thus the keel modules are distributed from a longitudinal centre line of the tower when in the deployed condition. This leads to a stable arrangement. The at least one rod can be arranged to move translationally relative to its respective buoyancy aid. The at least one rod can be pivotably attached to its respective buoyancy aid and can be arranged for pivoting movement relative to its respective buoyancy aid. Each keel module can be connected to its respective buoyancy aid by a plurality of rods. Typically the float includes n buoyancy tanks, where n is in the range 2 to 6.

An embodiment can include a first rod connecting a first keel module to a first buoyancy tank, wherein the first rod is arranged to move relative to the first buoyancy tank to deploy the first keel member from a non-deployed position to a deployed position. An embodiment can include a second rod connecting a second keel module to a second buoyancy tank, wherein the second rod is arranged to move relative to the second buoyancy tank to deploy the second keel member from a non-deployed position to a deployed position. An embodiment can include a third rod connecting a third keel module to a third buoyancy tank, wherein the third rod is arranged to move relative to the third buoyancy tank to deploy the third keel member from a non-deployed position to a deployed position. An embodiment can include a fourth rod connecting a fourth keel module to a fourth buoyancy tank, wherein the fourth rod is arranged to move relative to the fourth buoyancy tank to deploy the fourth keel member from a non-deployed position to a deployed position. The first, second, third and fourth rods can each be arranged to move translationally with respect to their respective buoyancy tank. The first, second, third and fourth rods can each be pivotally attached to their respective buoyancy tank and can be arranged to pivoting movement with respect to their respective buoyancy tank.

In an embodiment, a plurality of rods can connect a respective keel module to a respective buoyancy tank. For example, 2 to 8 rods can be used, and preferably around 4 to 6 rods can be used. The rods can be distributed about the buoyancy tank to form a loose fitting cage that can move translationally relative to the buoyancy tank. The rods can be distributed equally about the buoyancy tank. The rods can be arranged parallel with one another. Alternatively, the rods can be inclined to one another. Typically the rods are inclined at the same angle. Typically each rod is inclined from a vertical axis by an angle that is less than or equal to 10 degrees, preferably is less than or equal to 5 degrees, and is preferably around 3 degrees. Having inclined rods enables the rods to be attached to their respective keel modules in a manner that minimizes bending loads in the keel structure. It also has the benefit of enabling the strand jacks to be located as close as possible to an edge of the respective buoyancy tank to reduce bending loads applied to the strand jacks. The rods can be distributed about a pitch circle, and are typically distributed evenly about the pitch circle. The rods can be connected together by at least one annular member.

The respective keel module can be located directly below the respective buoyancy aid, in the sense of being aligned with the respective buoyancy aid, in at least one of the non-deployed and deployed conditions. A major outer surface of the respective keel module can be arranged substantially parallel with a lower end face of the respective buoyancy aid. The plane of the keel module is transverse to a longitudinal axis of the respective buoyancy aid. The respective rod can be arranged to move relative to the respective buoyancy aid. In some embodiments, each respective rod can be pivotally attached to its respective buoyancy aid.

The drive system can be arranged to move each respective keel module with respect to its respective buoyancy aid. Typically at least one drive unit is mounted on each outer buoyancy aid, to move the buoyancy aid's respective keel module.

The float can include a central buoyancy aid, such as a central buoyancy tank. Preferably the tower is mounted on the central buoyancy aid. The central buoyancy aid can include a heave plate located towards its lower end. In some embodiments there is no keel module associated with the central buoyancy aid. The central buoyancy aid can be arranged to include some ballast water at the start of operations. This ballast water may be used to assist with tensioning a mooring system during installation. Further ballast water may be gradually discharged over time to offset the increase in marine growth weight on the submerged buoyancy aids. The central buoyancy aid can include a system for controlling the influx of water into the aid, and expulsion of water from the aid, in order to adjust the amount of water ballast contained therein.

The longitudinal axis of the at least one rod can be arranged parallel with a longitudinal axis of the tower. The longitudinal axis of the at least rod can be arranged parallel with a longitudinal axis of a respective buoyancy aid. Alternatively, the longitudinal axis of the at least one rod can be arranged inclined to the longitudinal axis of the tower. The longitudinal axis of the at least one rod can be arranged inclined to the longitudinal axis of the longitudinal its respective buoyancy aid.

The float can include a second set of buoyancy aids, such as a set of buoyancy collars. The second set of buoyancy aids can be removable from the float during an installation process. For example, each respective second buoyancy aid can be releasably attached to a respective first buoyancy aid. The second set of buoyancy aids can provide additional stability to the wind turbine before the keel is deployed. The second set of buoyancy aids can be removed from the float after the keel is deployed to a sufficient depth to stabilise the wind turbine. Using a second set of floating aids enables a more compact arrangement of the first set of floating aids to be used.

A dynamic cable can be provided that transfers electrical power generated by the wind turbine to a sub-station. The cable can connect the wind turbine directly to the sub-station or via several interconnected floating units.

According to another aspect of the invention there is provided a wind turbine for deployment offshore, including: a tower-float assembly having a tower for supporting a nacelle and a rotor, and a float arranged to maintain at least part of the tower above a surface of a body of water; a keel assembly including at least one keel module and at least one rod connecting the keel module to the tower-float assembly, wherein the at least one rod is arranged to move translationally along a rectilinear path relative to the tower-float assembly to deploy the keel module, and the keel module is movable relative to the tower-float assembly, in response to movement of the at least one rod, between a non-deployed position proximal the tower-float assembly and a deployed position which is distal from the tower-float assembly in a downwardly direction, thereby increasing an effective length of the wind turbine.

According to another aspect of the invention there is provided a wind turbine for deployment offshore, including: a tower-float assembly having a tower for supporting a nacelle and a rotor, and a float arranged to maintain at least part of the tower above a surface of a body of water; a keel assembly including at least one keel module and at least one rod connecting the keel module to the tower-float assembly, wherein the at least one rod is pivotally attached to the tower-float assembly and is arranged for pivoting movement relative to the tower-float assembly to deploy the keel module, and the keel module is movable relative to the tower-float assembly, in response to movement of the at least one rod, between a non-deployed position proximal the tower-float assembly and a deployed position which is distal from the tower-float assembly in a downwardly direction, thereby increasing an effective length of the wind turbine, wherein the keel module moves along a curved path to the deployment position. For example, the keel module can move along an arc of a circle.

According to another aspect of the invention there is provided a method for installing a wind turbine offshore. The method includes: providing a wind turbine having a tower-float assembly including a tower for supporting a nacelle and a rotor, and a float arranged to maintain at least part of the tower above a surface of a body of water; a movable keel including at least one keel module; and at least one rod connecting the keel module to tower-float assembly.

The method can include providing a submersible barge having a deck; mounting the wind turbine on the deck of the submersible barge; the submersible barge transporting the wind turbine to an installation site in a manner wherein the deck can be located above the surface of the water; at a launch site, the submersible barge sinking into the water such that the deck can be submerged below the surface of the water; and the wind turbine floating off the submerged deck.

The method can include moving the keel module from a non-deployed position proximal to the tower-float assembly to a deployed position distal from the tower-float assembly.

The method can include providing a drive system having at least one drive unit arranged to move the keel and the drive system moving the keel from a non-deployed position proximal to the tower-float assembly to a deployed position distal from the tower-float assembly.

The method can include removing at least one drive unit from wind turbine after the keel is moved to the deployed position. The method can include removing a plurality of drive units from the wind turbine after the keel is moved to the deployed position. Preferably all drive units are removed. This enables the drive units to be reused and saves them from damage caused by environmental conditions, for example can save them from corrosion.

The wind turbine can be arranged according to any configuration described herein.

The method can include returning the barge to a quayside after the wind turbine separates from the barge. When the barge returns to the quayside, it can be used again to install a new wind turbine.

The method can include moving the keel module vertically downwards to the deployed position. The keel can be constrained to move vertically downwards only.

The method can include moving the keel module along a curved path, such as an arcuate path, from the non-deployed position to the deployed position.

The method can include at least partly assembling the wind turbine on the deck of the submersible barge. The barge can be moored at the quayside and component parts are lifted onto the deck via lifting apparatus such as a crane. Assembling the wind turbine on the barge frees up space on the quayside.

Assembling the wind turbine can include mounting a keel, or component parts thereof, onto the barge deck. If component parts of the keel are mounted onto the deck, the components parts of the keel can be fixed together on the deck.

Assembling the wind turbine can include mounting at least one buoyancy aid, such as a buoyancy tank, on to at least one of the keel modules and the deck. For example, at least one buoyancy aid can be mounted on to at least one keel module.

Assembling the wind turbine can include connecting a plurality of buoyancy aids, such as a plurality of buoyancy tanks, together to form the float. Connecting the buoyancy aids together preferably takes place on the barge. The buoyancy aids can be connected together by bracing members.

The float can be formed by connecting a first set of buoyancy aids together; and releasably attaching a second set of buoyancy aids to the first set of buoyancy aids. The first set of buoyancy aids can comprise a set of buoyancy tanks. The second set of buoyancy aids can comprise a set of buoyancy collars.

Assembling the wind turbine can include movably attaching a first set of rods to a first buoyancy aid, such as a first buoyancy tank, and connecting the first set of rods to a first keel module.

Assembling the wind turbine can include movably attaching a second set of rods to a second buoyancy aid, such as a second buoyancy tank, and connecting the second set of rods to a second keel module. The second set of rods are movably connected to the second buoyancy aid.

Assembling the wind turbine can include movably attaching a third set of rods to a third buoyancy aid, such as a third buoyancy tank, and connecting the third set of rods to a third keel module. The third set of rods are movably connected to the third buoyancy aid.

Assembling the wind turbine can include releasably attaching at least one drive unit to the first buoyancy aid, and preferably a first set of drive units.

Assembling the wind turbine can include releasably attaching at least one drive unit to the second buoyancy aid, and preferably a second set of drive units.

Assembling the wind turbine can include releasably attaching at least one drive unit to the third buoyancy aid, and preferably a third set of drive units.

Assembling the wind turbine can include mounting a tower onto the float, and preferably on top of a central buoyancy aid, such as a central buoyancy tank.

Assembling the wind turbine can include mounting a nacelle and rotor onto the tower.

The barge can be moored at a quayside during the assembly process. As the barge moves away from the quayside towards the launch site another submersible barge can be moved to the quayside for assembly of another wind turbine. For example, a barge that has recently returned from the launch site. This improves the wind turbine productivity and quayside utilization.

The keel comprises a plurality of keel modules and the method can include filling at least one keel module with ballast. Preferably the ballast includes solid material, for example an ore such as iron ore. The ballast can be provided in the form of a slurry. The ballast can be pumped into a hollow space within a keel module housing. The housing can include holes arranged to allow liquid in the slurry to escape, leaving solid material within the housing. The ballast can be pumped from a ship, which can moor alongside the barge.

The method can include filling the keel module with solid ballast, such as iron ore. The keel modules can be filled with ballast at the installation site, for example from a ship.

The method can include fixing the position of the wind turbine with mooring tethers. The wind turbine can include at least one of tether deployment devices and tensioning devices. The method can include tensioning the tethers with tensioning devices. In some embodiments the tensioning devices can be fitted as an integral part of the mooring tethers. The tensioning devices can be operated underwater. In some embodiments at least one of the available drive units can be used to power the tensioning devices. This obviates the need for a separate drive unit. Alternatively a power source that is provided for the drive units can also provide power to tensioning device drive systems. In normal operation the tensioning devices and keel drive units function separately.

The method can include reattaching the drive units and raising the keel.

According to another aspect of the invention there is provided a method for installing a wind turbine, the method including mounting the wind turbine onto a deck of a submersible barge, moving the barge to an installation site, submerging the barge so that the deck is below a surface of the water, and separating the wind turbine from the barge. The wind turbine can be arranged according to any configuration described herein.

According to another aspect of the invention there is provided a wind turbine for deployment offshore, including: a tower-float assembly having a tower for supporting a nacelle and a rotor, and a float arranged to maintain at least part of the tower above a surface of a body of water; and a keel assembly including a keel and at least one rigid connector member connecting the keel to tower-float assembly. The at least one rigid connector member can comprise a rod. The at least one rigid connector member can be moveably attached to the tower-float assembly, and the keel can be movable between a non-deployed position proximal the tower-float assembly and a deployed position distal from the tower-float assembly. The wind turbine can include a drive system having at least one drive unit arranged to move the keel between the non-deployed and deployed positions. In preferred embodiments the at least one drive unit can be releasably attached to the tower-float assembly and can be removable from the tower-float assembly after the keel can be moved to the deployed position.

### BRIEF DESCRIPTION OF THE DRAWINGS

Embodiments of the present invention will now be described, by way of example only, with reference to the accompanying drawings in which:

FIG. 1 shows a first prior art floating wind turbine in a first operating condition;

FIG. 2 shows the wind turbine of FIG. 1 in a second operating condition;

FIG. 3 shows a second prior art floating wind turbine in a first operating condition;

FIG. 4 shows the wind turbine of FIG. 3 in a second operating condition;

FIG. 5 is an isometric view of a wind turbine according to a first embodiment of the invention, which includes a tower, a float, and a keel that is movable with respect to the float;

FIG. 6 is an enlarged isometric view of a lower part of the wind turbine of FIG. 5;

FIGS. 7a to 7c show a drive system that is use to deploy the keel;

FIGS. 8 to 15 illustrate a wind turbine installation process;

FIG. 16 shows a drive system for use in a second embodiment of the invention;

FIG. 17 shows a wind turbine according to a third embodiment of the invention having an arrangement of buoyancy collars temporarily attached to a float to improve the buoyancy of the float;

FIG. 18 shows a float and keel structure of a wind turbine in accordance with a fourth embodiment of the invention, the keel structure being in a deployed condition;

FIG. 19 shows a detailed upper end of a part of the float structure shown in FIG. 18, together with a drive system, when the keel structure is in a non-deployed condition;

FIG. 20 shows a detailed lower end of a part of the float structure shown in FIG. 18, when the keel structure is in a deployed condition; and

FIG. 21 shows a float and keel structure of a wind turbine in accordance with a fifth embodiment of the invention, with the keel structure being in a non-deployed condition; and

FIG. 22 shows the float and keel structure of FIG. 21, with the keel structure being in a deployed condition.

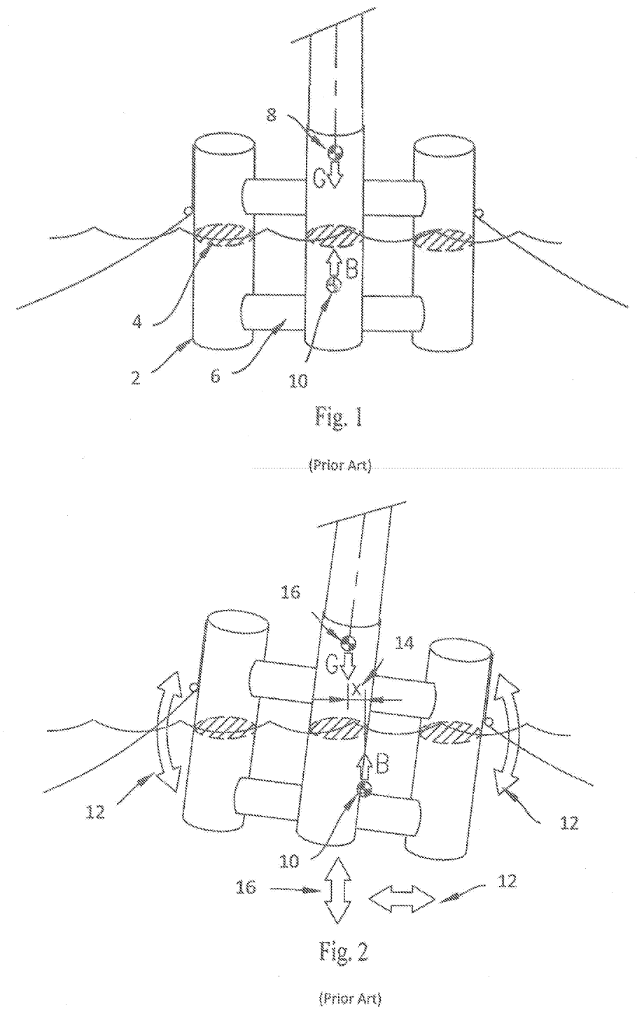

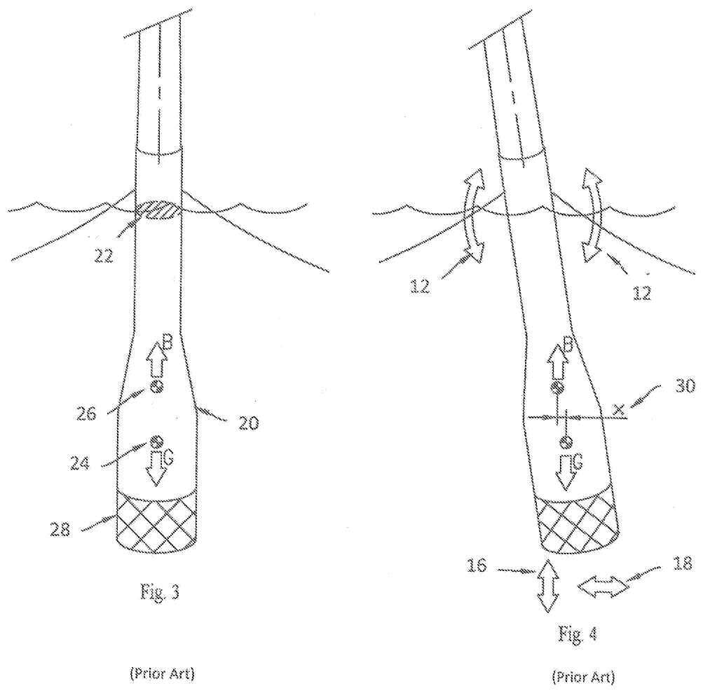

### DETAILED DESCRIPTION OF EMBODIMENTS OF THE INVENTION

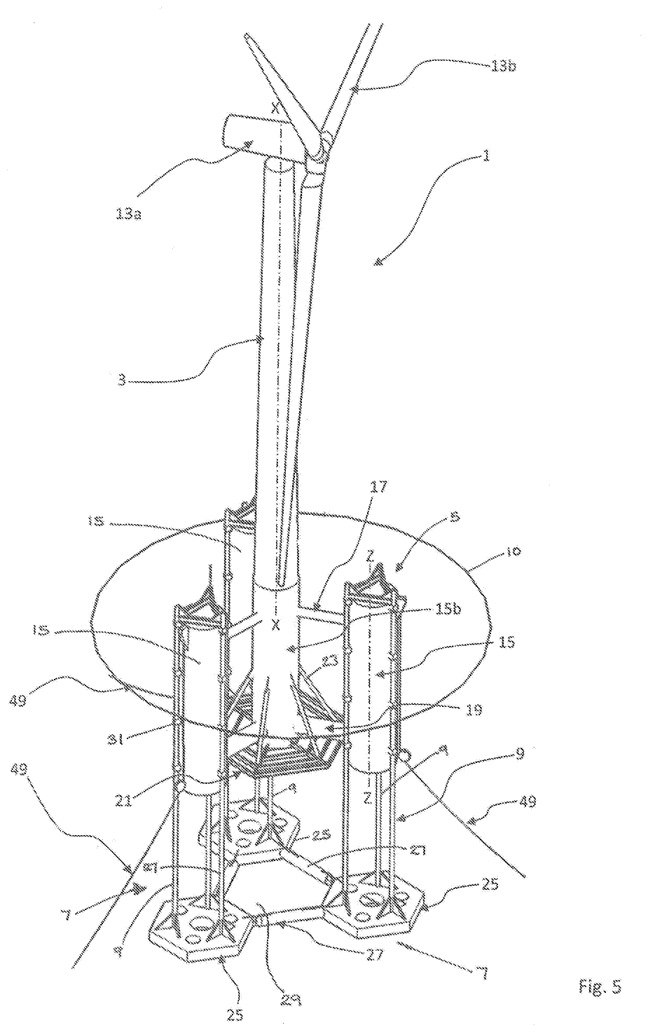

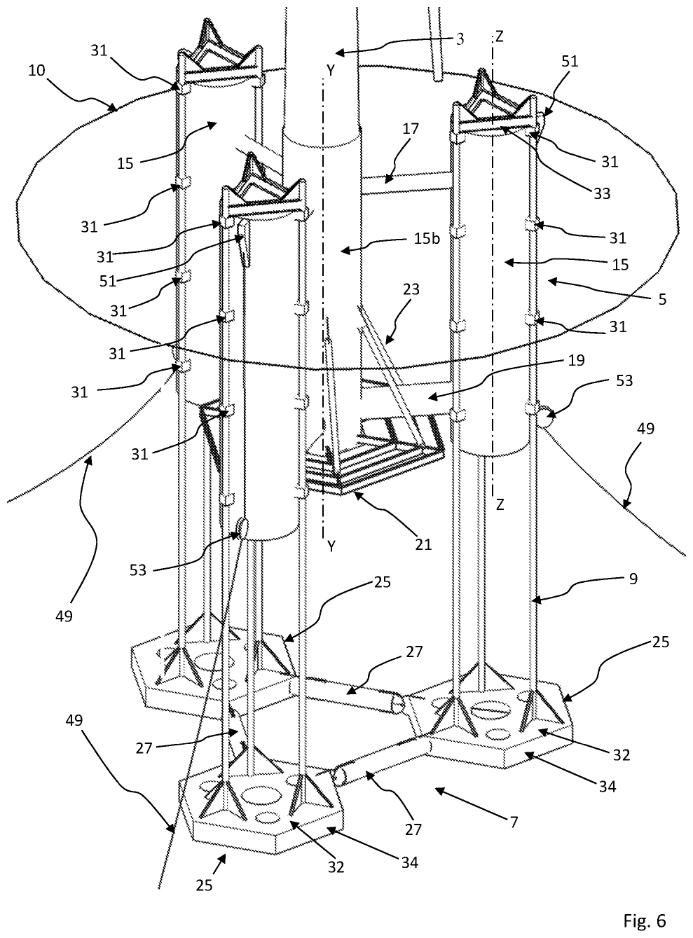

FIGS. 5 to 7c show a wind turbine 1 in accordance with a first embodiment of the invention. The wind turbine 1 includes a tower 3, a float 5, a keel 7, connector members 9, and a drive system 11 for moving the keel 7. The wind turbine also includes a nacelle 13a and a rotor 13b mounted on the tower 3.

The tower 3 and float 5 together are referred to as the tower-float assembly. The keel 7 and connector members 9 together are referred to as the keel assembly.

The purpose of the float 5 is to maintain the tower 3 above the surface of the sea 10, in its correct orientation (substantially vertical) to ensure that the rotor 13b and nacelle 13a can operate properly. The float 5 effectively provides a floating hull for the tower 3, nacelle 13a and rotor 13b. The float 5 comprises a plurality of buoyancy aids, preferably in the form of buoyancy tanks 15. Each buoyancy tank 15 comprises a cylindrical drum that is closed at each end. Each buoyancy tank 15 can be made from steel, and/or other materials such as concrete, carbon fibre, and glass reinforced plastic (GRP). Each buoyancy tank 15 has a central longitudinal axis Z-Z. Each buoyancy tank 15 is oriented such that the central longitudinal axis is arranged substantially vertically, and therefore the tanks are arranged as floating columns. In the arrangement shown in FIG. 5 there are three outer buoyancy tanks 15. Each outer buoyancy tank 15 is arranged at the apex of a triangle, and preferably an equilateral triangle, when viewed in plan. A central buoyancy tank 15b is located centrally between the three outer buoyancy tanks 15. The central buoyancy tank 15b has a central longitudinal axis Y-Y, which is arranged parallel with the longitudinal axes of the outer buoyancy tanks 15. Each outer buoyancy tank 15 is connected to the central buoyancy tank 15 by upper and lower bracing members such as braces 17,19. The upper and lower braces 17,19 protrude radially outwards from upper and lower parts of the central buoyancy tank 15 respectively. The upper and lower braces 17,19 connect to upper and lower parts respectively of the outer buoyancy tanks 15. The braces 17,19 fix the outer buoyancy tanks 15 to the central buoyancy tank 15b.

Optionally, a heave plate 21 can be attached to a lower end of the central buoyancy tank 15b. The heave plate 21 is arranged transversely to the longitudinal axis Y-Y of the central buoyancy tank 15b. Bracing members 23 can be used to further support the heave plate 21. The heave plate 21 has a larger width (or diameter) than an underside of the central buoyancy tank 15b. As shown in FIG. 5, the heave plate 21 can have a hexagonal shape, when viewed in plan.

The tower 3 is mounted on top of the central buoyancy tank 15. The tower 3 has a central longitudinal axis X-X that is arranged co-axially with the central longitudinal axis Y-Y of the central buoyancy tank 15b.

The keel 7 provides resistance to heave motion, and helps to stabilize the wind turbine. The keel 7 is movably attached to the float-tower assembly and is arranged to move from a non-deployed position adjacent to the lower parts of the buoyancy tanks 15,15b to a deployed position, which is distal from the lower parts of the buoyancy tanks 15,15b. That is, the keel 7 is moveable from a non-deployed position that is relatively shallow in the water to a deployed position which is located deeper in the water. The keel 7 is moved vertically upwards and downwards. Adjusting the position of the keel 7 adjusts the positon of a centre of mass of the wind turbine. Deploying the keel 7 effectively increases the length of the wind turbine, which has the effect of moving the centre of mass downwards. Having a lower centre of mass provides a more stable wind turbine.

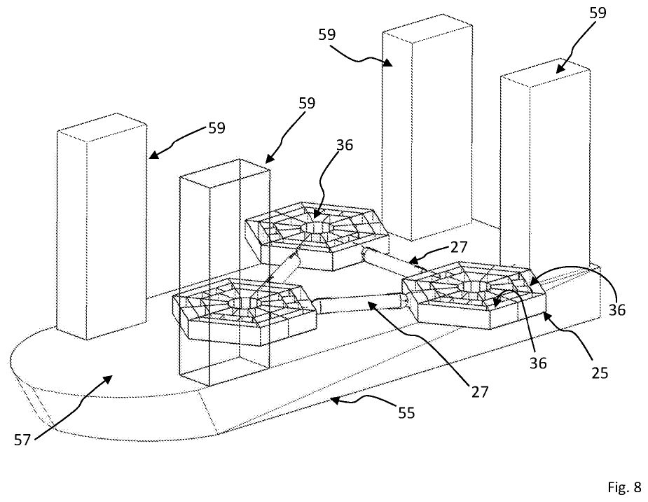

The keel 7 has a modular construction, which comprises a plurality of keel modules 25. In the arrangement shown in FIG. 5, the keel 7 includes three keel modules 25. Each keel module 25 comprises a housing. Each housing is filled with ballast to weigh the keel 7. Typically solid ballast is used. For some applications each housing can be filled with a slurry. Each housing typically has a plate-like overall structure, that is, the housing can have an overall structure that is relatively flat, like a disk. The housing can comprise upper 32 and lower planar walls, vertical side walls 34 and a hollow interior (see FIG. 8). The hollow interior comprises a grillage, which gives a cellular structure 36. Each keel module 25 can have a hexagonal shape when viewed in plan. The housing structure can include beams, such as steel. The beams can comprise beam sections, such as I, H and channel sections. The beams can be used for external vertical walls 34 and/or internal vertical walls of the housing. Plates, such as steel plates, can be provided for upper 32 and lower walls of the housing. The housing can be made from steel reinforced concrete.

Typically, each keel module 25 is associated with a respective outer buoyancy tank 15 and is arranged to move with respect to its buoyancy tank 15. Each keel module 25 is positioned below its respective outer buoyance tank 15, and is arranged to move in a direction that is substantially co-axial with the longitudinal axis Z-Z of the respective buoyancy tank.

As shown in FIG. 5, a preferred arrangement of the keel 7 is that the keel modules 25 are located in a plane, and each keel module 25 acts as a heave plate. The plane is transverse to the longitudinal axes Z-Z of the outer buoyancy tanks 15. Each keel module 25 is located within the plane at the apex of a triangle, and preferably an equilateral triangle, when viewed in plan. Each keel module 25 is preferably connected to at least one other keel module 25 by way of a bracing member 27, and preferably is connected to a plurality of other keel modules 25. The bracing members 27 provide the keel 7 with a rigid structure, and help to prevent the rods 9 from flexing. Optionally, the bracing members 27 can be of the type that can be adjusted. For example, the length of the bracing members 27 can be adjusted to tension the keel structure after installation. The keel 7 moves as a unit with respect to the tower-float assembly during deployment and retraction of the keel 7. The position of the keel 7 is fixed with respect to the float 5 when the keel 7 is in the deployed position. An aperture 29 is formed by the keel modules 25 and bracing members 27. The aperture 29 is located centrally. The aperture 29 is aligned with the heave plate 21.

The connector members are in the form of rods 9. The rods 9 connect the keel 7 to the tower-float assembly. The keel 7 is moveably connected to the tower-float assembly. Each rod 9 has a fixed length, and is preferably tubular. At least one rod 9, and preferably a plurality of rods 9, connects the keel 7 to each of the outer buoyancy tanks 15. In FIG. 5, a set of three rods 9 is provided per keel module-buoyancy tank pair. Respective rods 9 in each set protrude perpendicularly upwards from an upper surface 32 of the respective keel module 25. Additionally, or alternatively, the rods 9 can be connected to an interior surface of the keel module 25. Lower (distal) ends of the rods 9 are fixed to their respective keel module 25. Upper (proximal) ends of the rods 9 are fixed together by bracing members 33. The rods 9 in each set of rods are arranged substantially parallel with one another. The rods 9 in each set of rods are distributed evenly around the outer surface of the respective buoyancy tank 15. This provides a well-balanced arrangement. The rods 9 are movably connected to the outer buoyancy tanks 15 by at least one guide 31. A plurality of guides 31 is provided for each rod 9. Four guides 31 per rod are shown in FIG. 5. The number of guides 31 is in part determined by the height of the outer buoyancy tank 15. The guides 31 are arranged to enable each rod 9 to slide along a rectilinear path. For example, the guides 31 can be mounted on an outer surface of the buoyancy tank 15 in sets, and preferably on a curved outer surface. Each set of guides 31 is associated with one of the rods 9. The guides 31 in a set of guides are arranged along a line on the outer surface, and spaced apart along the length of buoyancy tank 15. Thus each rod 9 is constrained to move along a single axis. Thus each keel module 25 is constrained to move vertically upwards and downwards. This enables the keel 7 to be moved vertically downwards when deployed.

The length of the rods 9, and hence the deployment depth of the keel 7, is selected in accordance with the size of the wind turbine and the environmental conditions. The rods 9 have a sufficient length to enable the keel 7 to be deployed to the deployment position. Consequently, the rods 9 tend to have a much larger length than the height of the buoyancy tanks 15. It will be appreciated that some wind turbines may require a deeper or shallower deployment. The deployment position is determined according to the design of the wind turbine.

At least some of the rods 9, and preferably each rod 9, include a set of drive formations 35, for interacting with the drive system 11. Each drive formation 35, can be for example a tooth-like sheer plate that protrudes radially outwards from the rod 9. In a preferred arrangement, the drive formations 35 are spaced apart along at least part of the length of the rod and are arranged in at least one line. Preferably at least some drive formations 35 protrude outwardly in a first radial direction. Preferably at least some drive formations 35 protrude radially outwardly in a second direction. Typically the second direction is opposite to the first direction. One of the first and second directions can be towards the respective buoyancy tank 15.

The drive system 11 is arranged to deploy the keel 7 by lowering it deeper into the sea. The drive system 11 is also arranged to retract the keel 7 by raising it to a shallower depth. The drive system 11 achieves this by interacting with drive formations 35 to move the rods 9 upwards or downwards as required, which drives movement of the keel 7. At least part of the drive system 11 is removable from the tower-float assembly, which allows the drive system 11 to be reused. Allowing for delays and repairs, six drive systems 11 can be cycled during a typical windfarm installation campaign. This reduces the cost of the installation. Also, after the installation has been completed, the drive system 11 can be returned to shore. The drive system 11 can be reinstalled on a wind turbine for maintenance or decommissioning. The drive system 11 can be stored and maintained onshore for use in future field developments. In one arrangement, the drive system 11 includes a set of drive units, for example in the form of hydraulic cylinders 37. The drive system 11 preferably includes a rigid frame 39. Typically, at least one hydraulic cylinder 37 is provided for each rod 9. Each hydraulic cylinder 37 is releasably attachable to its respective buoyancy tank 15 adjacent its respective rod 9, for example each cylinder 37 can be bolted to the tank 15 or can make use of a quick release mechanism such as clamps or toggles. Having hydraulic cylinders 37 that are releasably attachable to the buoyancy tanks 15 enables the cylinders 37 to be removed from the tower-float assembly after the keel 7 has been deployed. This enables the hydraulic cylinders 37 to be used on other wind turbines in the installation, thus fewer drive systems 11 are required than the total number of wind turbines in an installation.

The hydraulic cylinders 37 on each buoyancy tank 15 are connected together by the frame 39. The frame 39 includes engagement formations 41 that are arranged to engage and release the drive formations 35. The frame 39 is driven by the cylinders 37. The frame is able to move upwards or downwards according to the direction of action of the cylinders 37. The frame 39 lowers and lifts the keel 7 by selectively interacting with the drive formations 35. This is achieved by the engagement formations 41 selectively engaging and disengaging the drive formations 35. Thus the drive system 11 is able to selectively drive the rods 9 in upwardly and downwardly directions. Operation of the hydraulic cylinders 37 is synchronised to ensure that the keel is deployed evenly. For example a suitable control system can be provided to control operation of the hydraulic cylinders 37. When deploying the keel 7, the hydraulic cylinders 37 are synchronized to drain fluid at the same time thereby maintaining the frame 39 in a substantially horizontal orientation. When the hydraulic cylinders 37 reach the end of their stroke, stops 43 mounted to the buoyancy tank 15 temporarily fix the positions of the rods 9, for example by each stop 43 engaging one of the drive formations 35, which relieves the load on the hydraulic cylinders 37. The engagement formations 41 release their respective drive formations and the hydraulic cylinders 37 are then extended upwards to elevate the frame 39 to an upper position, wherein the engagement formations 41 engage a new drive formation 35 further up the rod 9. The stops 43 disengage the rods 9, and the cycle repeats until the keel 7 reaches the deployed position.

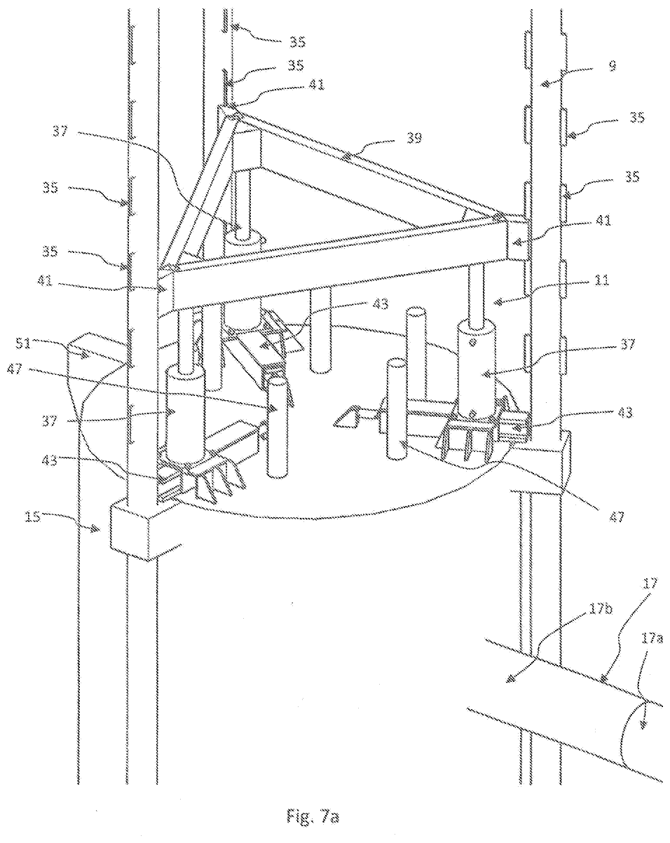

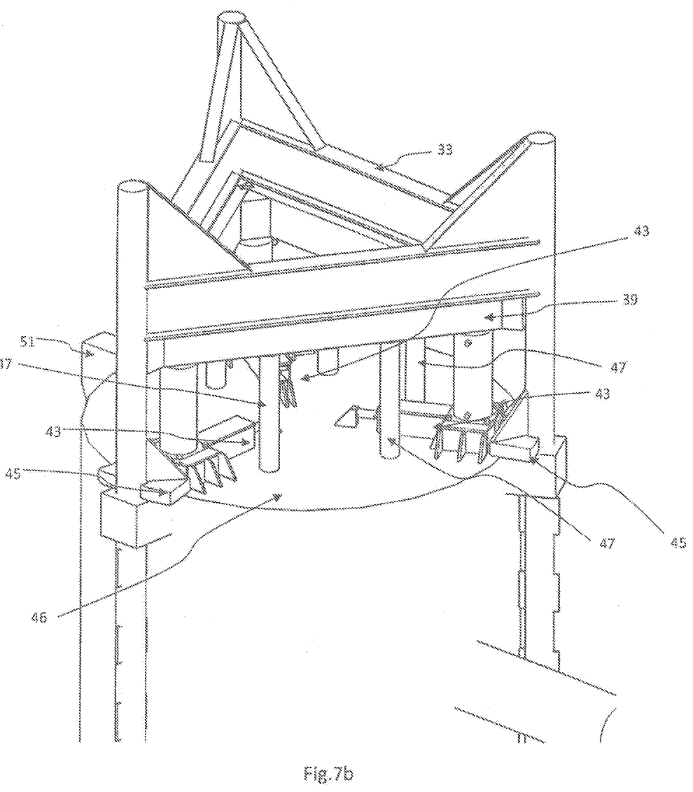

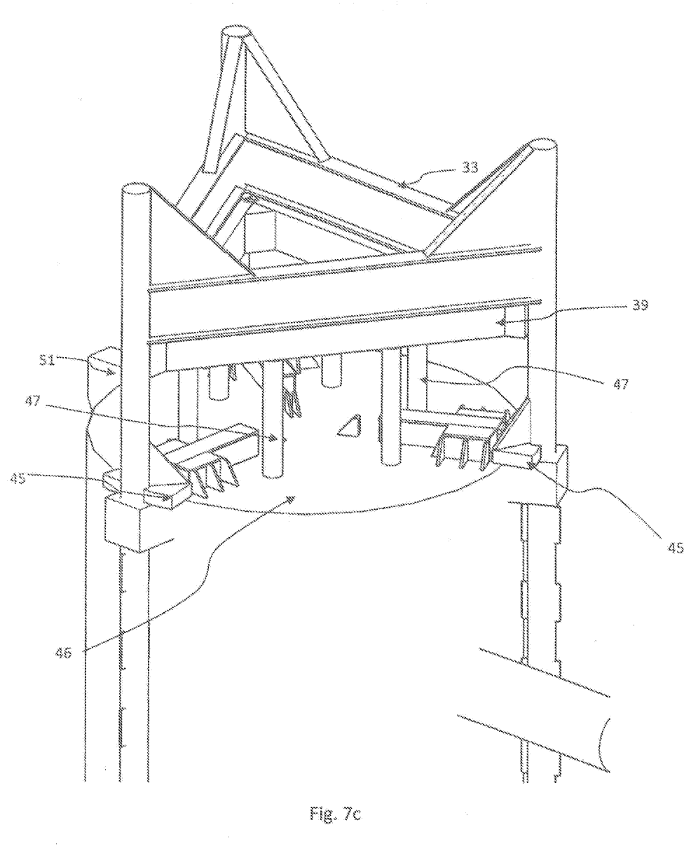

The deployed position for the keel 7 is achieved when the permanent shear stops 45, which are located towards upper ends of each rod 9 contacts an upper surface 46 of its respective buoyancy tank 15 (see FIG. 7b). The hydraulic cylinders 37 are fully closed and the rigid frame 39 rests on top of the support columns 47. The hydraulic cylinders 37 are not required for the normal operation of the wind turbine and so may be detached and removed from site and reused on subsequent floating foundations. FIG. 7c shows the top of the outer buoyancy tank 15 after removal of the drive units 37.

To lift the keel 7, for example for decommissioning or maintenance purposes, the hydraulic cylinders 37 are reinstalled on to the tower-float assembly and the above process is performed in reverse. For example, the engagement formations 41 drivingly engage the drive formations 35 at a low part of the cylinder 37 stroke, drive the rods 9 upwards, and then release the drive formations 35 at an upper part of the cylinder stroke.

The wind turbine is held in position using mooring lines 49, which connect to cable/chain tensioning units 51 at deck level via sheaves 53 mounted lower down the float 5. Additionally, or alternatively, tensioning units fitted as an integral part of the mooring line 49 and operated underwater may be used. The wind turbine floats with an operational water line at approximately below the height of the upper braces 17.

Since the rods 9 are rigid, the keel 7 reacts to dynamic transverse, pitch and roll loads by transmitting bending moments to the tower-float assembly. This makes the float 5 more responsive to motion of the keel 7 and the keel 7 more responsive to motion of the float 5. Thus the float 5, rods 9 and keel 7 behave as a single body, which makes the behaviour of the wind turbine more predictable. If cables rather than rigid rods 9 were to support the keel 7 from the float 5, the cables typically would not transmit bending moments from keel 7 to tower-float assembly nor from tower float assembly to keel 7. Motion of the float 5 would not be as responsive to motion of the keel 7. Likewise, motion of the keel 7 would not be as responsive to motion of the float 5. Typically a cable connection would allow the float 5 and keel 7 to move more independently as two separate bodies. In particular, the mass moment of inertia of a single body system is greater than for a two body system. The rigid rod system thus presents a larger resistance to dynamic loading in rotation and improved wind turbine generation performance.

Having an adjustable keel 7 helps to ensure that the centre of mass of the wind turbine is located below the centre of buoyancy when the keel 7 is deployed. This allows reduction of the footprint of the final assembly. Hence, less space is required at the assembly site and a barge assembly technique becomes feasible. When the geometry of the wind turbine and its mass distribution is such that its centre of mass is below its centre of buoyancy in operation, then the single body behaves in operation as a spar foundation. The required water plane area to achieve stability is less than if the single body behaved as a semi-submersible foundation in which the centre of mass is above the centre of buoyancy.

Furthermore the single body retains sufficient static stability with the keel 7 retracted for assembly, transportation and launch phases.

In addition to the lower ends of the buoyancy tanks 15,15b, the keel 7 geometry has a planar top surface and a planer bottom surface, which are orientated transversely to the direction of heave. This generates added mass and damping effects which reduces heave motion of the wind turbine. The tower-float assembly's response to the wave spectrum at any given geographic location may thus be engineered by a suitable selection of the keel's surface area, mass and depth to achieve an optimum added mass, damping coefficient and mass moment of inertia.

A method for installing a wind turbine will now be described with reference to FIGS. 8 to 15.

Component parts of the keel assembly and tower-float assembly are fabricated and gathered together adjacent an assembly quay. Typically the components are of a weight defined by the capacity of an available shore side crane.

A submersible installation barge 55 moors alongside the assembly quay. The barge 55 has a deck 57 that is fitted with buoyancy tanks 59 to enable controlled sinking of the cargo barge.

The fabricated component parts are loaded onto barge 55 sequentially and assembled in a sequence that minimizes assembly time.

The keel modules 25 are laid flat on the deck 57 (see FIG. 8). If required, the keel modules 25 are connected together by bracing members 27. The keel modules 25 include internal cells 36 that are filled with solid ballast either prior to lifting onto the barge 55 or after mounting on the deck 57. The solid ballast is preferably crushed mineral ore, and is preferably supplied to the keel modules 25 in the form of a slurry. For example, the slurry can be pumped from a cargo vessel preferably via a water pumped slurry system. The cargo vessel may moor alongside the barge 55 and fill the empty cells 36 of each keel module 27 with the slurry. Water drains through holes formed in keel module walls leaving solid ballast material filling the cells 36.

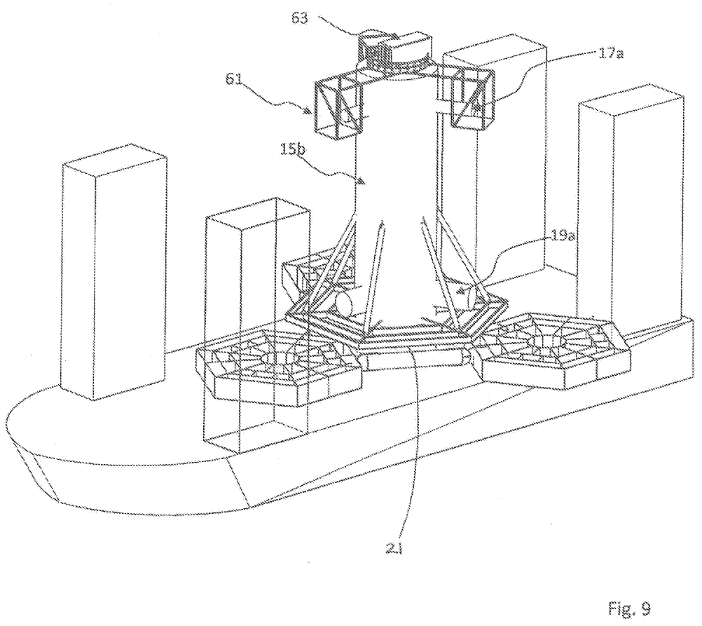

The central buoyancy tank 15b is mounted centrally, optionally with the heave plate 21 pre-attached to the lower end of the tank (see FIG. 9). The central buoyancy tank 15b is positioned ready for connection to the outer buoyancy tanks 15, for example by welding or a mechanical connection. Temporary access platforms 61 and plant 63 may be installed on top of the central buoyancy tank 15 to support the works, if applicable.

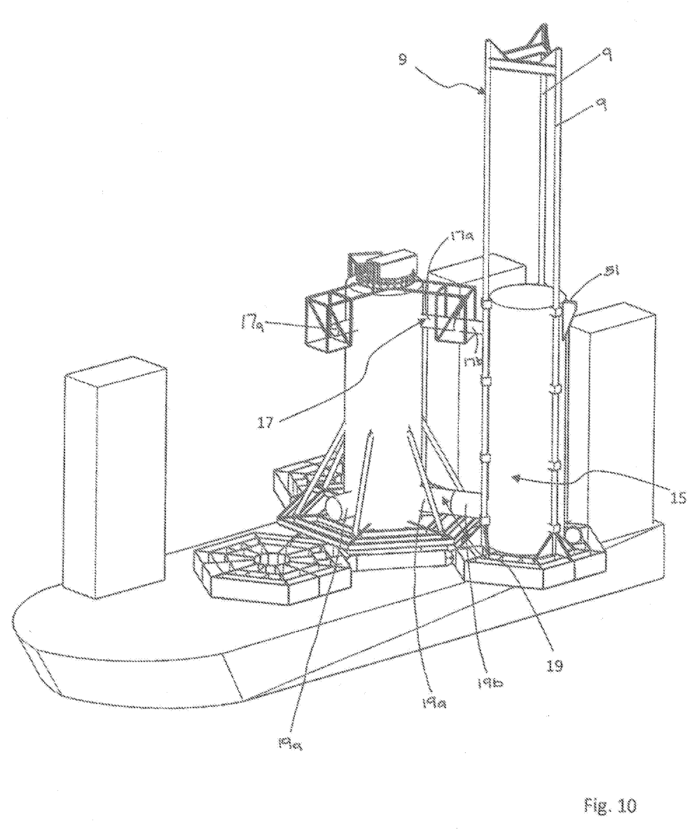

A first outer buoyancy tank 15 is placed on top of one of the keel modules 25 (see FIG. 10). Preferably the rods 9 are pre-attached to the first outer buoyancy tank via guides 31. The upper brace 17 comprises a first portion 17a that protrudes outwardly from the central tank 15b and a second portion 17b that protrudes outwardly from the outer tank 15. The first and second parts 17a,17b are abutted end to end and connected together, for example by welding or other mechanical connection means. The lower brace 19 comprises a first portion 19a that protrudes outwardly from the central tank 15b and a second portion 19b that protrudes outwardly from the outer tank 15. The first and second parts 19a,19b are abutted end to end and connected together, for example by welding or other mechanical connection means. The lower end of each rod 9 is secured to its respective keel module 25 either by welding, pin and clevis arrangement, or other suitable means of connection.

Preferably, the drive system 11 is pre-installed on the tower-float assembly, typically on an upper surface of the outer buoyancy tank 15, prior to mounting the buoyancy tank 15 on to the barge 55. At least part of the drive system 11, which typically includes a hydraulic drive or an electric motor, is releasably attached to the tower-float assembly, for example using bolts, clamps and/or toggles.

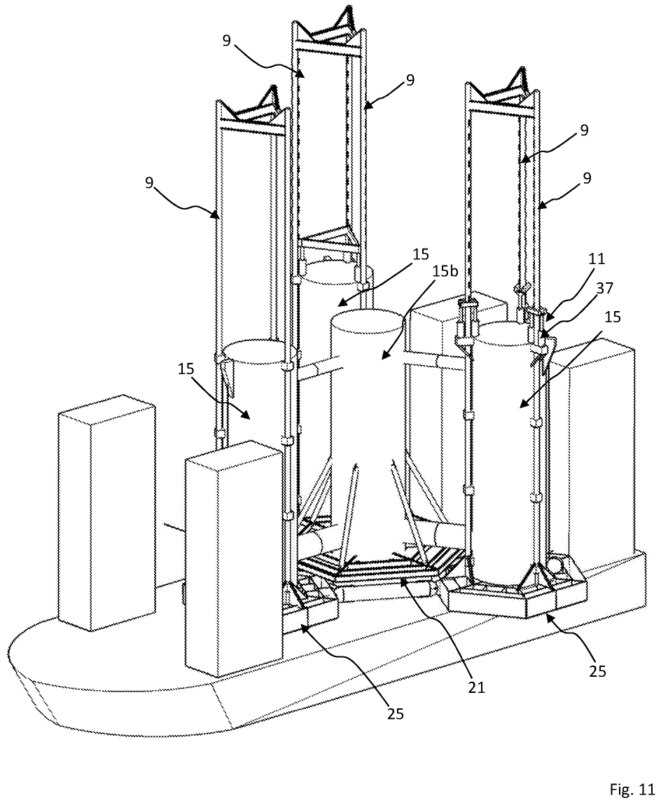

Each of the remaining outer buoyancy tanks 15 is then installed in a similar manner to the first outer buoyancy tank (see FIG. 11).

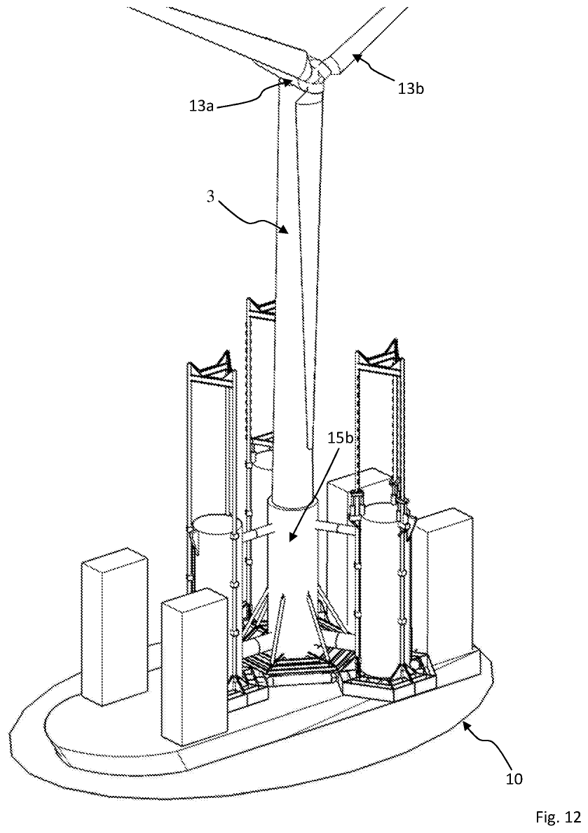

The tower 3, nacelle 13a and rotor 13b are mounted on to the central buoyancy tank 15b, typically on an upper surface thereof (see FIG. 12). This completes the assembly of the wind turbine.

The wind turbine 1 is tested and commissioned as fully as possible on the barge 55 before departure to the field.

The barge 55, with the wind turbine mounted thereon, is towed out to the launch location, or travels under its own motion if powered. As the barge 55 clears the quay, an optional second barge may moor alongside the quay to start the assembly process for another wind turbine. It will be apparent that the keel 7 is in the non-deployed position at this stage.

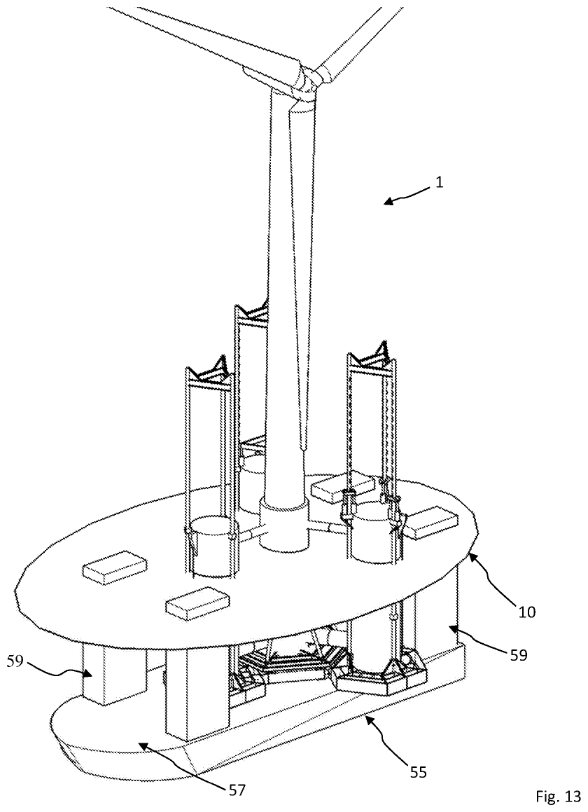

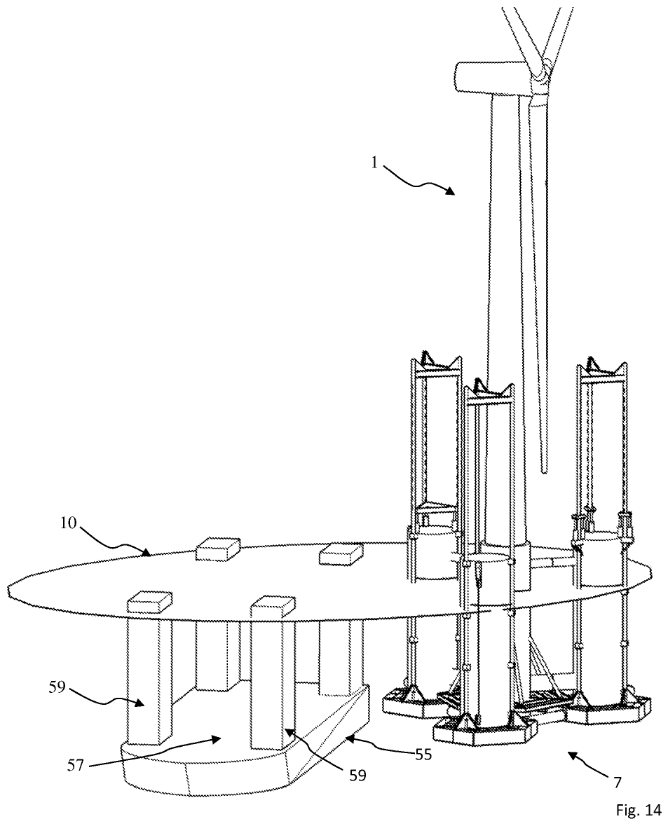

When at the launch location, ballast tanks in the hull of the barge 55 are flooded in a controlled sequence. The barge 55 submerges and the buoyancy tanks 59 maintain a water plane area and hence intact stability (see FIG. 13). As the barge 55 submerges, the wind turbine 1 becomes self-buoyant and detaches from the barge deck 57. The barge 55 and wind turbine 1 separate from one another. The wind turbine 1 is towed clear of the barge 55 and is taken to its target installation position. FIG. 14 shows the submerged barge moved clear of the wind turbine 1.

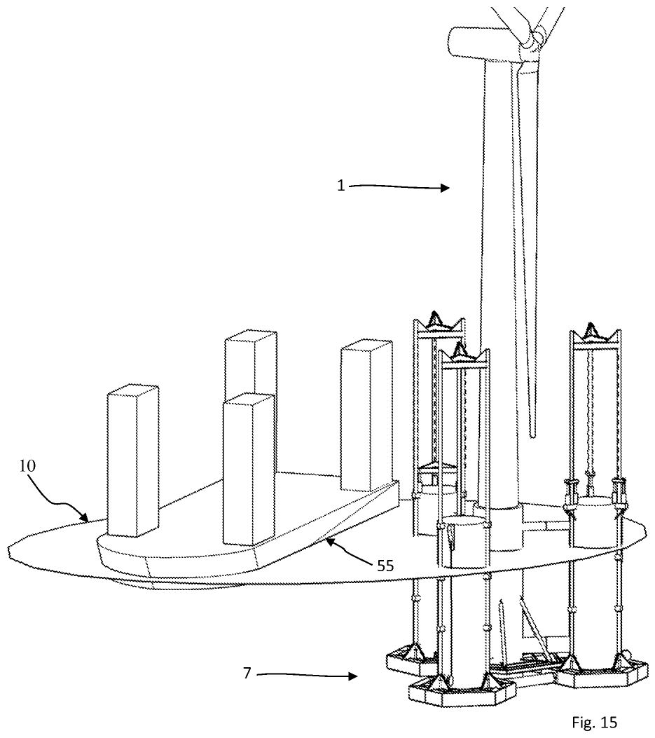

The barge 55 resurfaces (see FIG. 15) and returns to port to repeat the assembly and load out operation.

The keel modules 25 are lowered by the drive system 11 to the deployed position. The deployed position is at a greater depth than the non-deployed position. The drive system 11 lowers the rods 9 downwards, thereby increasing the depth at which the keel modules 25 are located. The drive system 11 drives the rods 9. Movement of the rods 9 is constrained by the guides 31. Each rod 9, and hence the keel module 25, is constrained to move along an axis. Each axis is substantially vertical in calm seas. The deployed position is typically achieved when the rods 9 have completed the maximum extent of their stroke.

The mooring lines 49 are attached to the sea bed to fix the location of the wind turbine 1.

The installation method has the following, advantages:
Since assembly of the wind turbine 1 takes place on the deck 57 of the barge 55 the area of the quayside required during the assembly process is minimized.
Using a barge 55 for the assembly process minimizes the time the floating turbine assembly spends in port by enabling movement of the barge 55 as in a production line to separate work stations each, optimized for either float assembly or turbine assembly. This avoids concentration of material, tooling and personnel at a single work station and allows separate assembly work to take place simultaneously.
A continuous assembly process can be set up that uses three separate barges each following the other between: a float assembly workstation; a turbine assembly workstation; and the installation site location to maintain a continuous installation process.
Having barges available enables installed wind turbines to be moved, should that be necessary. For example, a wind turbine can be moved from the installation site using one of the available barges to a new installation site, or to a marine port for maintenance or decommissioning as a dry hull.

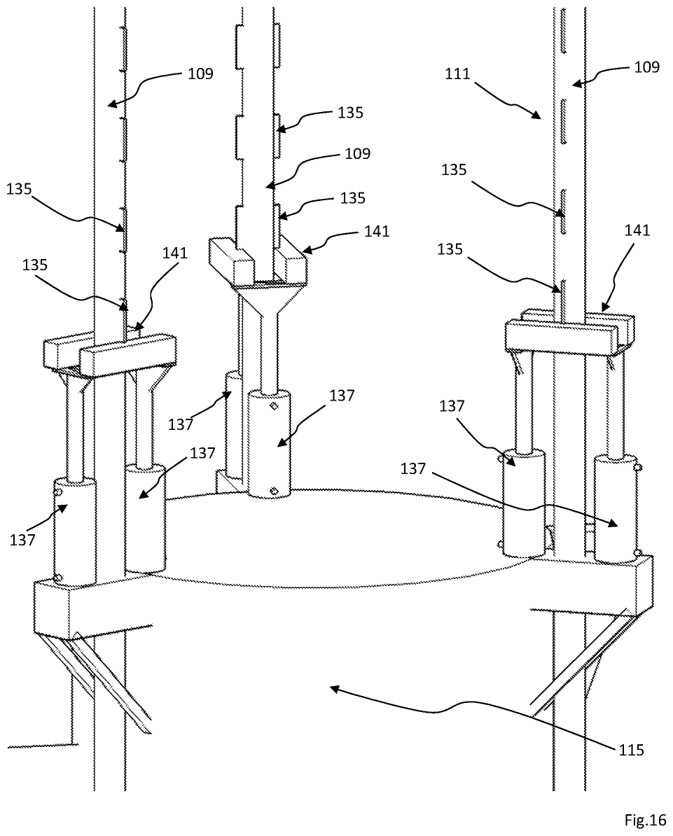

Part of a wind turbine in accordance with a second embodiment of the invention is shown in FIG. 16. The wind turbine in accordance with the second embodiment is similar to the first embodiment except that the drive system 111 has a different arrangement from the drive system 11.

In the second embodiment, a pair of drive units, preferably in the form of a pair of hydraulic cylinders 137 is provided for each rod 109. The drive units 137 are mounted on an outer buoyancy tank 115. Each cylinder includes a drive device 141 for selectively engaging the drive formations 135 formed on the rods 109. This provides a more compact rigid design.

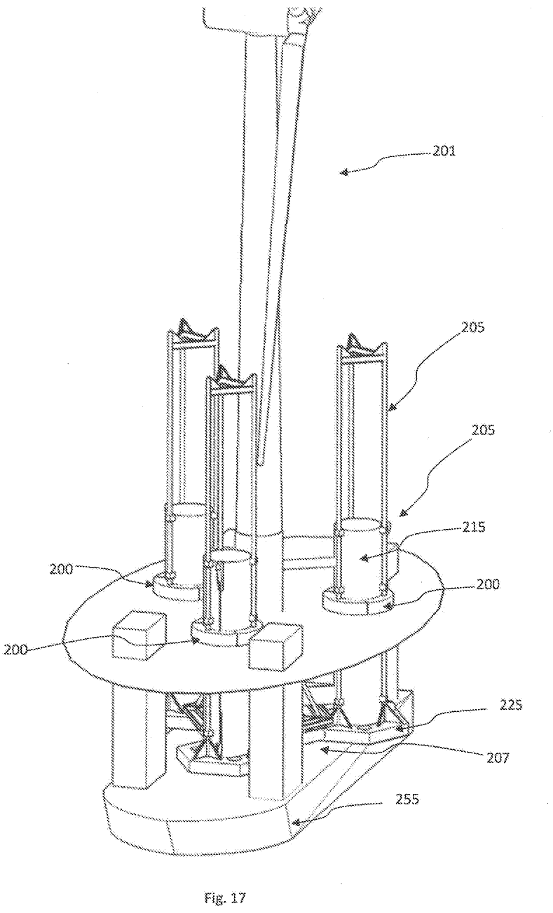

A wind turbine 201 in accordance with a third embodiment is shown in FIG. 17. The wind turbine according to the third embodiment is similar to the first embodiment, or second embodiment, except that the float 205 can include buoyancy collars 200 fitted to the outer buoyancy aids (see FIG. 17), such as outer buoyancy tanks 215, The buoyancy collars 200 provide additional buoyancy to the float 205 during the installation process. Preferably the buoyancy collars 200 are releasably attached to the outer buoyancy tanks 215. The buoyancy collars are typically removed prior to normal operation of the wind turbine. The buoyancy collars 200 can include apertures and/or recesses to enable the rods 209 to move relative to the buoyancy collars 200. For example, the buoyancy collars 200 may be fitted temporarily to the outer buoyancy tanks 215 during the assembly phase. The collars provide additional buoyancy and stability to the float 205 prior to the keel 207 being at least partially deployed. The buoyancy collars are typically removed after the wind turbine has floated off the barge 255 and after the keel modules 225 have been lowered to a sufficient depth to ensure static stability of the wind turbine without the need for the buoyancy collars. This allows for a more compact float 205 configuration.

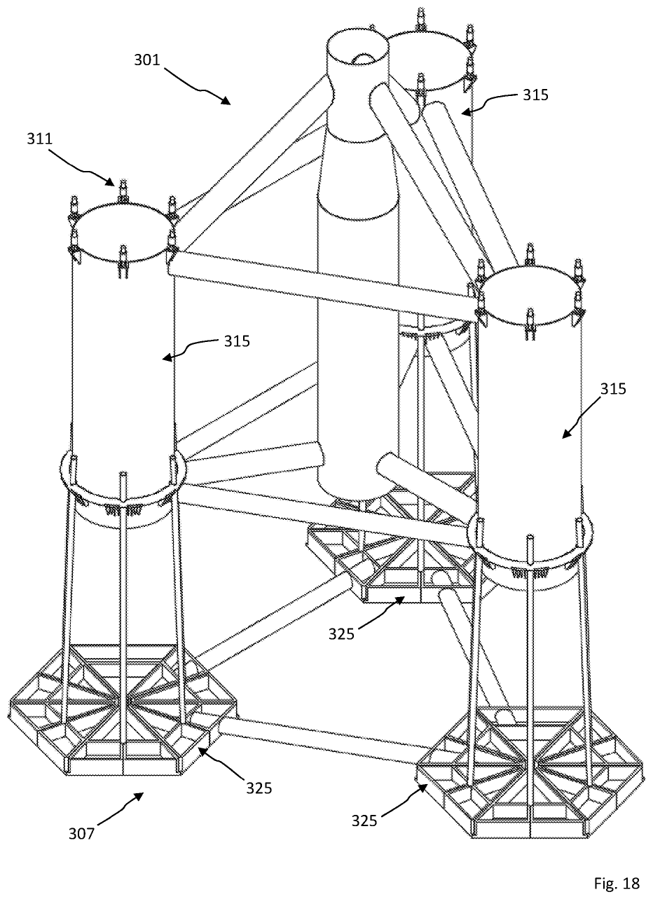

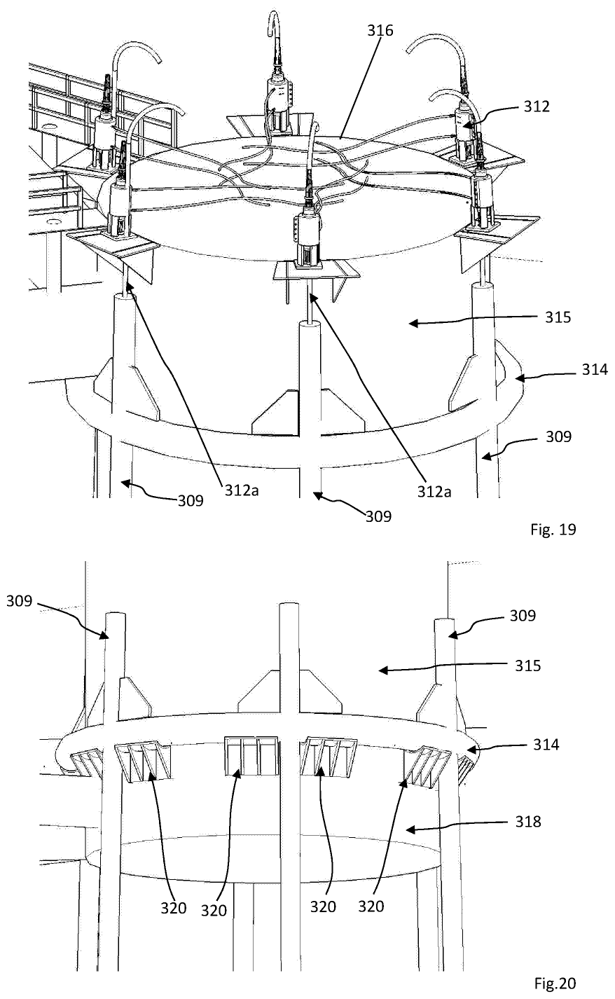

FIG. 18 shows buoyancy tanks 315 and a keel 307 of a wind turbine 301 in accordance with a fourth embodiment of the invention. The keel 307 comprises a plurality of keel modules 325. The embodiment can be arranged similar to the first, second or third embodiments, except that the drive system 311 used to move the keel 307 from the non-deployed to the deployed conditions is different. In the fourth embodiment the drive system 311 includes an arrangement of strand jacks 312 to move the keel 307 from the non-deployed to the deployed conditions. As shown in FIGS. 18 and 19, a plurality of strand jacks 312 are mounted on upper ends 316 of each buoyancy tank 315. Typically a strand jack 312 is provided for each rod 309 (six are shown in FIGS. 18 and 19). Each strand jack 312 includes a feedable drive element 312a, which are sometimes referred to as steel cable strands, that is used to drive its respective rod 309 in an axial direction. The rods 309 are each constrained to move along a respective rectilinear path in a generally vertical direction. This drives the respective keel module 325 along a rectilinear path in a generally vertical direction. A strand jack is an established technology that is suitable for the purpose of deploying the rods 309.

The rods 309 that are associated with a particular buoyancy tank 315, and a particular keel module 325, are connected together by an annular member 314. The annular member 314 is located towards the upper ends of the rods 309.

FIG. 20 shows a lower end 318 of a buoyancy tank 315, when the keel 307 is the deployed condition. Brackets 320 are located towards the lower end 318 of each buoyancy tank. The brackets 320 limit movement of the rods 309, and therefore define the deployed position of the keel 307. The annular member 314 engages the brackets 320 and arrests movement of the rods 309.

After the keel 307 has been deployed, the strand jacks 312 can be removed from each buoyancy tank 315, for example can be used on another wind turbine.

In this embodiment the keel 307 comprises a plurality of keel modules 325, one keel module per buoyancy tank. Each keel module 325 is rigidly attached to its respective rods 309, for example the rods 309 can fit into sockets located in the keel module housing. The keel modules 325 are connected together. The drive system 312 can be arranged to move the keel modules 325 simultaneously, for example by synchronising operation of the strand jacks 312. In some arrangements, the keel modules 325 are not connected together and the drive system 312 can be arranged to move the keel modules 325 independently of each other.

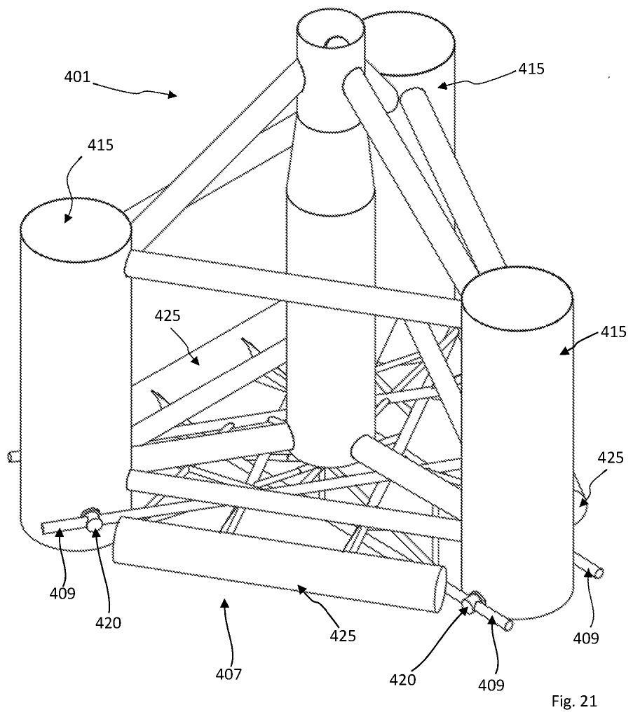

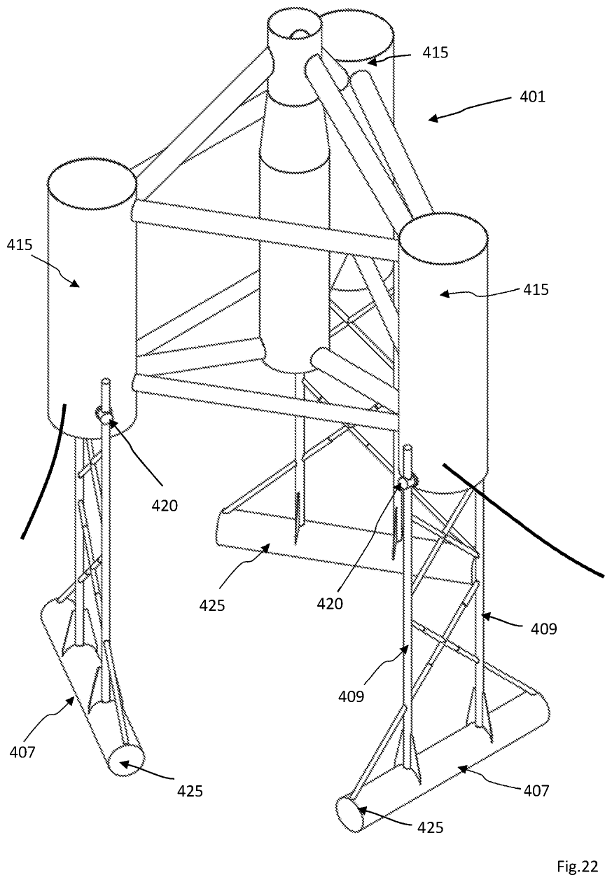

FIG. 21 shows buoyancy tanks 415 and a keel 407 of a wind turbine 401 in accordance with a fifth embodiment of the invention. This embodiment differs from the preceding embodiments in that the rods 409 are pivotally attached to their respective buoyancy tanks 415 by pivot pins 420. In FIG. 21 pairs of rods 9 are pivotally attached to their respective buoyancy tank 415, typically towards the lower end of the buoyancy tank. The rods 409 are located on opposite sides of the respective buoyancy tank 415, and are typically diametrically opposite to one another.

The keel 407 comprises a plurality of keel modules 425, typically one for each buoyancy tank 415. Each keel module 425 is connected to one of the pairs of rods 409. Preferably the keel module is cylindrical, with the longitudinal axis of the cylinder being arranged perpendicular to the longitudinal axes of the rods 409. This means that the keel module 425 can be used as a float during transportation. The keel module 425 is typically attached to the distal ends of the respective pair of rods 409.

Each pair of rods 409 is arranged to pivot through an angle of approximately 90 degrees, moving its respective keel module 425 from a non-deployed position to a deployed position. Each pair of rods 409 is arranged to pivot from a generally horizontal orientation, in the non-deployed condition, to a generally vertical orientation in the deployed condition. The pairs of rods 409 are arranged to fold inwards. The arrangement is such that, when each pair of rods 409 is in a generally horizontal orientation, at least one pair of rods 409 overlies at least one other pair of rods 409 (see FIG. 21, which shows a folded arrangement). To facilitate this, the pivot axes of each pair of rods 409 are vertically offset from one another, to allow nestling of the pairs of rods 409 in the non-deployed condition.

The pairs of rods 409 can be limited to pivot through 90 degrees by means of appropriate blocking members or a suitable mechanism. Typically, the blocking members are arranged to prevent the pairs of rods 409 pivoting beyond the vertical direction.

The system includes a locking mechanism that is arranged to lock the orientation of respective pairs of rods with respect to their buoyancy tank 415. For example, the locking mechanism can be arranged to lock respective pairs of rods in the deployed orientation, i.e. in a generally vertically orientation. The locking mechanism ensures that the rods 409 are locked to their buoyancy tanks 415 so that the overall arrangement acts as a single body.

In this embodiment a drive system is not needed to move the keel modules 425 from the non-deployed positions to the deployed positions. During transit, the keel modules 425 can be filled with air. Due to the reduced displacement of the assembly's launch and transit condition, the wind turbine may be launched in the shallow waters of a port facility rather than requiring a submersible barge to assist launch into deeper costal waters. When located at the site of use, each keel module 425 can be filled with ballast. A preferred ballast is a solid ore, such as iron ore, that can be provided by a dredge pumping ship. This removes the ballasting operation off the critical path during on-shore assembly of the wind turbine 401. The weight of ballast in the keel modules 425 causes the keel modules 425 to sink under the action of gravity thereby rotating respective pairs of rods 409 about their respective pivot axes until the keel module 425 reaches its deployment position. Thus a drive system is not required to deploy the keel modules 425.

Of course, a drive system can be used to assist with the controlled deployment of the keel modules 425 if desired.

Although the present invention has been described in connection with specific preferred embodiments, it should be understood that the invention as claimed should not be unduly limited to such specific embodiments. Furthermore, it will be apparent to the skilled person that modifications can be made to the above embodiment that fall within the scope of the invention.

For example, the drive system can include at least one drive unit in the form of an electric motor and a suitable drive mechanism for driving each rod 9. A suitable drive mechanism may comprise a rack and pinion drive gear system or other drive mechanism suited to the environment and mode of operation. One drive motor and rack and drive mechanism can be provided per rod 9. In another arrangement one drive motor and drive mechanism can be provided per keel module 25.

More than one type of drive system 11 can be included in a wind turbine. For example, some buoyancy tanks 15 may include a drive system 11 according to the first embodiment, while other buoyancy tanks may include a drive system 11 according to the second embodiment.

A different number of buoyancy aids can be used.

A different number of keel modules 25 can be used. The number of keel modules 25 typically matches the number of outer buoyancy tanks.

The keel 7 can have a different arrangement from that shown. For example, the keel 7 does not have to have a triangular arrangement. The keel modules 25 can have different shapes from hexagonal.

The keel modules 25 can comprise open concrete boxes.

The drive devices 41,141 be in the form of hydraulic clamps.

In some embodiments at least one rod can comprise first and second tubular members concentrically arranged. This is to help provide a sufficient tensile capacity to take dynamic loading and fatigue margin for the life of the rod. The second tubular member can be located within the first tubular member. The second tubular member can be fixed to the first tubular member.

The central buoyancy tank can be arranged to include some ballast water at the start of operations. This ballast water may be used to assist with tensioning the mooring system during installation. Further ballast water may be gradually discharged over time to offset the increase in marine growth weight on the submerged buoyancy tanks. The central buoyancy tank can include a system for controlling the influx of water into the tank, and expulsion of water from the tank, in order to adjust the amount of water ballast contained therein.

The buoyancy collars 200 can comprise solid buoyancy blocks or inflatable buoyancy units.

1.-40. (canceled)

41. A wind turbine for deployment offshore, including:
a tower-float assembly having a tower for supporting a nacelle and a rotor, and a float arranged to maintain at least part of the tower above a surface of a body of water;
a keel assembly including at least one keel module and at least one rod connecting the keel module to the tower-float assembly, wherein the at least one rod is arranged to move relative to the tower-float assembly to deploy the keel module, and the keel module is movable relative to the tower-float assembly, in response to movement of the at least one rod, between a non-deployed position proximal the tower-float assembly and a deployed position which is distal from the tower-float assembly in a downwardly direction, thereby increasing an effective length of the wind turbine; wherein the at least one rod is pivotally attached to the tower-float assembly and is arranged for pivoting movement relative to the tower-float assembly such that the keel module is moveable from the nondeployed position to the deployed position along a curved path; and the at least one rod is arranged to transfer bending moments between the keel module and the tower-float assembly in a deployed condition.

42. A wind turbine according to claim 41, wherein the at least one rod is arranged to transmit at least one of compressive forces and shear forces between the keel module and the tower-float assembly in the deployed condition.

43. A wind turbine according to claim 41, wherein the at least one rod is arranged to pivot through an angle of approximately 90 degrees from a non-deployed condition to the deployed condition.

44. A wind turbine according to claim 41, wherein the at least one rod is arranged generally horizontally when the keel module is in the non-deployed position and the at least one rod is arranged generally vertically when the keel module is in the deployed position.

45. A wind turbine according to claim 41, further including a plurality of rods connecting the keel module to tower-float assembly.

46. A wind turbine according to claim 41, further including a plurality of keel modules.

47. A wind turbine according to claim 46, wherein the at least one rod comprises a first rod connecting the keel member to the tower-float assembly, the first rod is pivotally attached to the tower float assembly at a first pivot axis; and including a second rod connecting a second keel member to the tower-float assembly, the second rod is pivotally attached to the tower float assembly at a second pivot axis, wherein the second rod is arranged to overlap the first rod when the keel module and second keel module are each in their respective non-deployed positions.

48. A wind turbine according to claim 41, wherein at least one rod is tubular.

49. A wind turbine according to claim 45, wherein the plurality of rods are connected together by bracing members.

50. A wind turbine according to claim 41, wherein at least one keel module includes a housing.

51. A wind turbine according to claim 50, wherein the housing has a hollow interior and the hollow interior is arranged to be filled with ballast.

52. A wind turbine according to claim 41, wherein the at least one rod has a length that is greater than or equal to 30 m.

53. A wind turbine according to claim 41, wherein there is a rigid connection between the at least one rod and the keel module.

54. A wind turbine according to claim 41, wherein at least one rod has a fixed length.
